(19) United States
(12) Patent Application Publication
(10) Pub. No.: US 2017/0300630 A1
(43) Pub. Date: Oct. 19, 2017

(54) INFORMATION PROCESSING SYSTEM, INFORMATION PROCESSING METHOD, AND RECORDING MEDIUM

(71) Applicant: CANON KABUSHIKI KAISHA, Tokyo (JP)

(72) Inventors: Masahiro YAKAMI, Kyoto-shi (JP); Yutaka EMOTO, Kyoto-shi (JP); Hiroyuki SEKIGUCHI, Kyoto-shi (JP); Toru KIKUCHI, Hino-shi (JP)

(21) Appl. No.: 15/483,764

(22) Filed: Apr. 10, 2017

(30) Foreign Application Priority Data
Apr. 13, 2016 (JP) 2016-080603

(51) Int. Cl. G06F 19/00

(52) U.S. Cl. CPC G06F 19/322; G06F 19/321

(57) ABSTRACT

An information processing system includes one or more processors, an acceptance unit configured to accept a specification of one piece of medical information in a set of a plurality of pieces of medical information being displayed on a display unit, a selection unit configured to select reference medical information from the set of medical information based on an associatin between a type of the specified medical information and a type of medical information which belongs to the set of medical information and which is different from the specified medical information, and a change unit configured to change an appearance of the reference medical information to an appearance different from an appearance of medical information other than the reference medical information in the set of the plurality of pieces of medical information.

### BACKGROUND OF THE INVENTION

### Field of the Invention

The present disclosure relates to an information processing system configured to perform a displaying process on medical information, an information processing method, and a recording medium.

### Description of the Related Art

In recent years, a remarkable improvement has been achieved in performance of a medical imaging apparatus, and thus correspondingly the amount of image data managed in a medical institution is increasing, which causes an increase in operation load in interpretation imposed on doctors. Furthermore, medical technologists are supposed to play a further role of assisting interpretation in image diagnosis. The assist in interpretation by medical technologists includes pre-detection of lesions, which is also called “pre-interpretation”, performed by medical technologists before interpretation is performed by doctors. Other interpretation assist techniques such as CADe (Computer Aided. Detection.), CADx (Computer Aided Diagnosis), and the like are under development. An interpretation doctor performs interpretation with reference to information obtained via pre-interpretation or CADe, performs image diagnosis, and generates an interpretation report.

To improve readability and/or reusability or interpretation reports including an increasing amount of information, a technique is known to structure interpretation reports when the interpretation reports are generated. US2012/0176408 discloses a technique in which a mark is displayed at a location of a lesion on a medical image to indicate that there is particular text information linked to the mark.

When a doctor refers to a report, it may be necessary for the doctor to acquire various kinds of information from the report, and thus information a user wants to obtain is not limited to an association between text information and a location of a lesion on a medical image. For example, when a doctor reads a report, the doctor may want to get to know an observation which is a basis for a diagnosis, other possible diseases suggested from the observation, information about other diseases related to the diagnosed disease, and/or the like.

### SUMMARY OF THE INVENTION

According to some embodiments of the present invention, an information processing system includes one or more processor, an acceptance unit configured to accept a specification of one piece of medical information in a set of medical information being displayed on a display unit, a selection unit configured to select reference medical information from the set of medical information based on an association between a type of the specified medical information and a type of medical information which belongs to the set of medical information and which is different from the specified medical information, and a change unit configured to change an appearance of the reference medical information to an appearance different from an appearance of medical information other than the reference medical information in the set of medical information.

Further features of the present invention will become apparent from the following description of exemplary embodiments with reference to the attached drawings.

### BRIEF DESCRIPTION OF THE DRAWINGS

FIG. 1 is a diagram illustrating a medical document display system.

FIG. 2 is a diagram illustrating a hardware configuration of a terminal apparatus.

FIG. 3A and FIG. 3B are diagrams each illustrating an example of a manner of displaying information on a display.

FIG. 4 is a diagram illustrating a software configuration of a terminal apparatus.

FIG. 5 is a diagram illustrating an example of interpretation report information.

FIG. 6 is a diagram illustrating an example of a selection condition DB.

FIG. 7A is a diagram for illustrating an example of a manner of highlighting information.

FIG. 7B is a diagram for illustrating an example of a manner of highlighting information.

FIG. 7C is a diagram for illustrating an example of a manner of highlighting information.

FIG. 7D is a diagram illustrating an example of a manner of displaying an icon to indicate existence of another related item.

FIG. 8 is a flow chart illustrating a main process.

FIG. 9 is a flow chart illustrating a process of highlighting reference medical information.

FIG. 10 is a diagram illustrating an example of a manner of highlighting information according to a first modification.

FIG. 11 is a diagram illustrating an example of a manner of highlighting information according to a second embodiment.

FIG. 12 is a flow chart illustrating a process of highlighting information according to the second embodiment.

FIG. 13 is a diagram illustrating an example of a manner of highlighting information according to the second embodiment.

FIG. 14 is a flow chart illustrating a manner of highlighting information according to a third embodiment.

### DESCRIPTION OF THE EMBODIMENTS

Embodiments of the present disclosure are described below with reference to drawings.

### First Embodiment

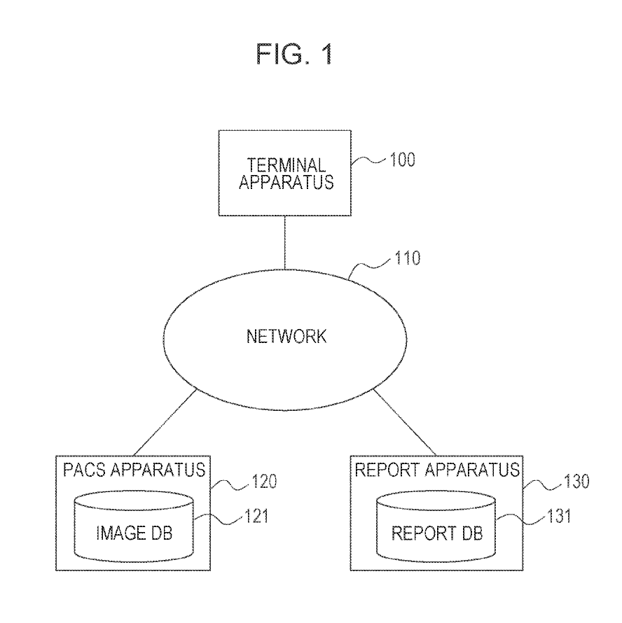

FIG. 1 is a diagram illustrating a medical document display system according to a first embodiment. In this first embodiment, it is assumed by way of example that the document display system displays, as medical information, an interpretation report of an image diagnosis in a medical field. However, information displayed by the document display system according to the present embodiment is not limited to a specific type of information as along as the information is medical information. For example, the document display system may display another type of diagnosis report.

The document display system includes a terminal apparatus 100, a PACS (Picture Archiving and Communication System) apparatus 120, and a reporting apparatus 130. The terminal apparatus 100 is an example of an information processing apparatus and an information processing system. The PACS apparatus 120 is a server which includes an image database (hereinafter referred to as an image DB) 121 and which provides a function of storing and reading a medical image via a network 110. The image DB 121 stores patient information, medical examination information, and a medical image in an associated manner. The patient information is information on a patient. The medical examination information is information on an examination. The medical image is a medical image captured by CT or MPI and stored in the DICOM (Digital Imaging and. Communications in Medicine) format.

The reporting apparatus 130 is a server including a report DB 131 and providing a function of storing and reading interpretation report information via the network 110. The report. DB 131 stores interpretation report information. The interpretation report information is information representing a report on a medical image, and more specifically, is information representing an observation on the medical image, a diagnosis based on the observation, an examination recommended, based on the diagnosis, to be performed, and/or the like. The observation is represented in a sentence or a value in terms of a feature of a condition, lesion, and/or an abnormal region of a patient obtained as a result of observing a medical image by a doctor or a medical technologist.

The terminal apparatus 100 reads out, from the reporting apparatus 130, an interpretation report on an examination specified to be displayed, and displays it. Furthermore, the terminal apparatus 100 reads out, from the PACS apparatus 120, a corresponding medical image according to specifying a key image, and displays it.

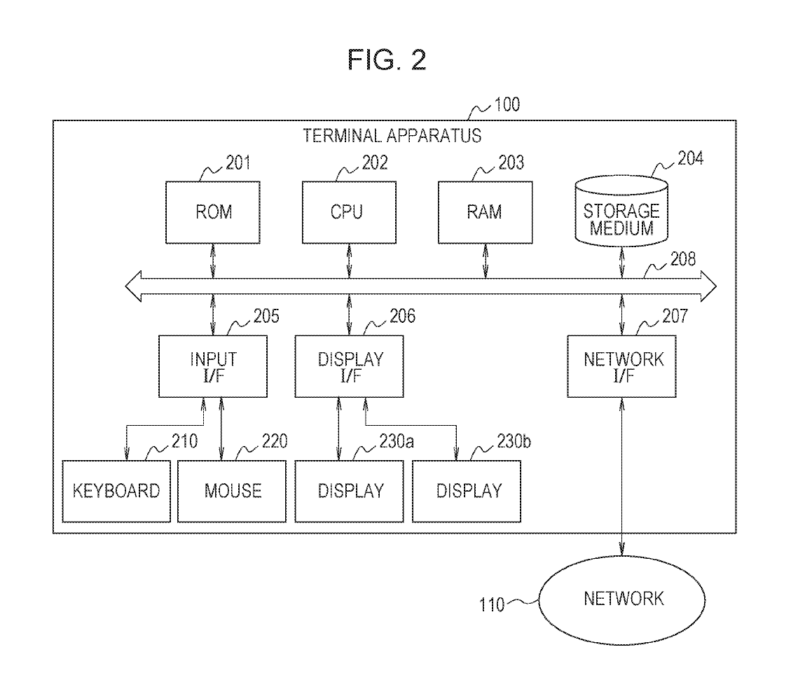

FIG. 2 represents a hardware configuration of the terminal apparatus 100. A storage medium 204 is a storage medium such as an HDD (Hard Disk Drive) or the like configured to store various kinds of information including an OS (Operating System), a processing program, and the like. A ROM (Read Only Memory) 201 stores a program such as BIOS (Basic Input/Output System) or the like for booting the OS. A CPU (Central Processing Unit) 202 performs an operation process in executing various programs. A RAM (Random Access Memory) 203 temporarily stores various kinds of information when the CPU 202 executes a program. The functions and the processes described later of the terminal apparatus 100 are realized by the CPU 202 by reading a program stored in the ROM 201 or the storage medium 204 and executing the program.

An input interface (hereafter referred to as an input I/F) 205 is a communication interface such as USB (Universal Serial Bus) for connecting an input device such as a keyboard 210, a mouse 220, or the like. A display I/F 206 is an interface such as a graphic board or the like for displaying a screen on displays 230a and 230b. A network I/F 207 is an interface according to a standard such as IEEE (Institute of Electrical and Electronics Engineers) 802.3ab or the like and for communication via the network 110. An internal bus 208 is a bus for use by each block in communicating with each other.

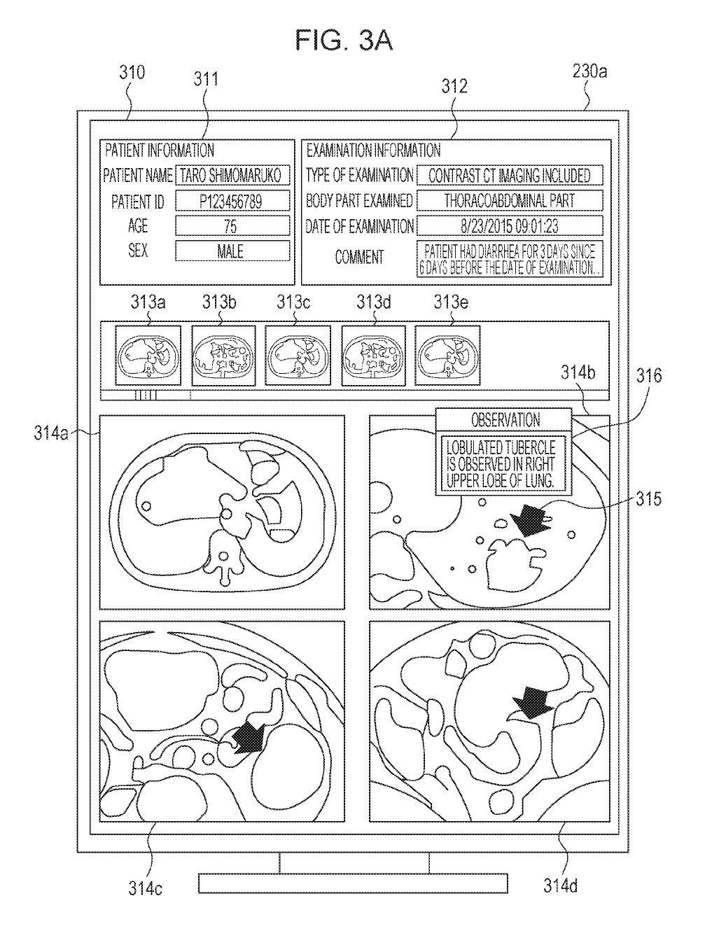

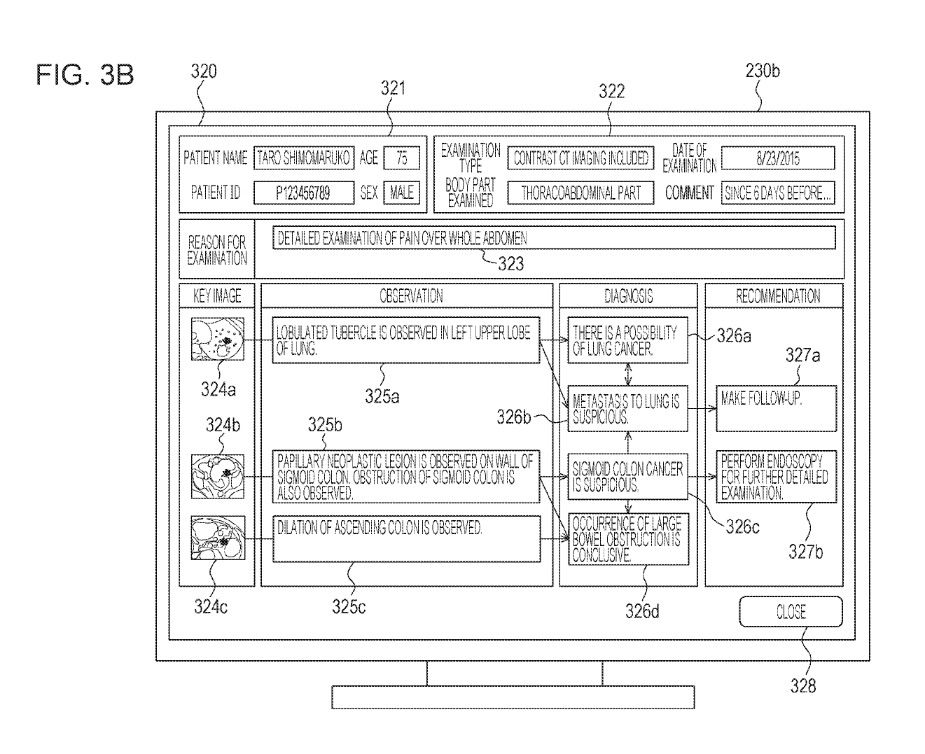

FIG. 3A and FIG. 3B illustrate examples of manners of displaying information on the respective displays 230a. and 230b. In the present embodiment, a viewer screen 310 is displayed on the display 230a, while an interpretation report screen 320 is displayed on the display 230b. The viewer screen 310 is a screen for displaying a medical image associated with an examination of a patient of interest. The interpretation report screen 320 is a screen for displaying an interpretation report of an examination of a patient of interest.

In the viewer screen 310, 311 denotes an area in which patient information is displayed. The patient information is information on a patient. In the present embodiment, the patient information includes a patient name, a patient ID, an age of a patient, a sex, and the like. 312 denotes an area in which medical examination information is displayed. The medical examination information is information on an examination. In the present embodiment, the medical examination information includes an examination type, an examination body part, an examination date, a comment, and the like.

Areas 314a to 314d are areas in which medical images are displayed. In these areas, it is possible to move a slice position to he displayed, change an image display condition such as WL (Window Level)/WW (Window Width), and display a graphical image such as ROI (Region of Interest). Key images 313a to 313e are key images of medical images obtained in the same examination. In response to a user's operation of dragging and dropping one of the key images 313a to 313e, a corresponding medical image is displayed in a corresponding one of the areas 314a to 314d.

A graphical image 315 is a graphical image added to an image to clearly indicate a location of a lesion or the like. The graphical image is not limited to an arrow but the graphical image may be a line, a rectangle, an ellipse, a circle, or the like. An observation window 316 is a window for displaying an observation sentence associated to the graphical image 315 or the medical image. The observation window 316 is displayed when a medical image is displayed. In an alternative example, the observation window 316 may be toggled between a displayed state and an undisplayed state in response to an operation. In a still alternative example, the observation window 316 may be automatically displayed when a medical image has been displayed over a predetermined period of time.

In the interpretation report screen 320, an area 321 is an area in which patient information is displayed. An area 322 is an area in which medical examination information is displayed. An area 323 is a display field in which a reason for an examination of interest is displayed. The area 323 is divided into sub-areas for respective reasons for examination. The information displayed in the area 323 may be generated by a requesting doctor who requests an examination via a system, or may be generated by an interpretation doctor when an interpretation report is generated, or may be generated from a natural sentence describing the reason for the examination by performing language analysis on it. Key images 324a to 324c are key images included in the interpretation report information. The key images each are a slice image representing a feature of an observation.

Observations 325a to 325c are observations. The observations 325a to 325c are connected to corresponding key images 324a to 324c via dines (with no arrowhead) to indicate correspondence between them. In the observations 325a to 325c, objective facts readable from corresponding images are described. The observations are not limited to those found by an interpretation doctor via observing an image, but the observations may include an observation found by a medical technologist via performing pre-interpretation, an observation found via image analysis such as CADe, or the like. Each observation may be displayed in such a manner (not illustrated) that entities that provided observations are distinguishable. For example, the appearance of an observation may be changed depending on whether the observation is given by a doctor or a medical technologist or via image analysis such as CADe.

Diagnoses 326a and 326b are diagnoses based on the observation 325a, and connected to the observation 325a via arrows each indicating a cause/basis. In the diagnoses, subjective information on a disease or the like determined from the observations is described. The relationship between the observations and the diagnoses may have a one-to-one, one-to-many, or many-to-one correspondence. 327a denotes a recommendation based on the diagnosis 326b, and is connected to the diagnosis 326b via an arrow indicating a cause/basis. In the recommendation, information on a recommended examination or the like depending on the content of the diagnosis is described. The relationship between the diagnoses and the recommendations may have a one-to-one, one-to-many, or many-to-one correspondence.

A bidirectional arrow between the diagnosis 326a and the diagnosis 326b indicates that a conflicting association exists between the diagnosis 326a and the diagnosis 326b. When two diagnoses have a conflicting association, both diagnoses cannot be true at the same time, and only one of the two diagnoses is true as the final diagnosis. In this example, a diagnosis that “there is a possibility of lung cancer” or a diagnosis that “metastasis to lung is suspicious” is possible for an observation that “lobulated tubercle is observed in left upper lobe of lung”. However, only one of the two possibilities is employed as a final diagnosis, that is, the diagnosis that the tubercle is lung cancer or metastasis to lung is employed as a final diagnosis. It may be possible to regard the tubercle as lung cancer or metastasis to lung and thus associations between them are equivalent. However, in the present embodiment, they are treated such that they have an association of cause/basis.

A diagnosis 326c is connected to the diagnosis 326b and also to a diagnosis 326d respectively via arrows to indicate that the diagnosis 326c is a cause/basis that results in the diagnoses 326b and 326d. In the example shown in FIG. 3B, it is shown that “sigmoid colon cancer” is a cause/basis of “metastasis to lung” and “large bowel obstruction”. A user is allowed to set a correspondence association (not shown) between medical information representing a reason for an examination and medical information representing an observation, a diagnosis, or a recommendation. In a case where there is a correspondence association between medical information representing a reason for an examination and medical information indicating an observation, a diagnosis, or a recommendation, if medical information indicating a reason for an examination is selected, associated medical information is highlighted as described later.

A button 328 is a “close” button. When this button is clicked, displaying of an interpretation report is ended. Note that types of information displayed, the layout of the displayed information, and the manner of displaying information or associations are merely examples and they are not limited to these examples.

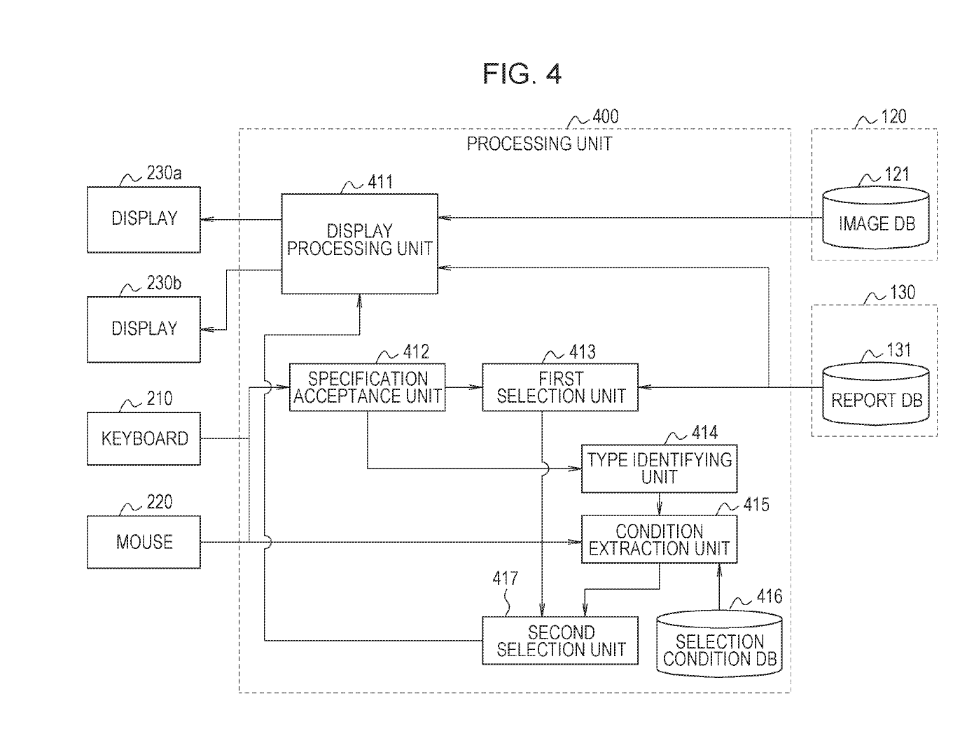

FIG. 4 is a diagram illustrating a software configuration of the terminal apparatus 100. In the terminal apparatus 100, a display processing unit 411 of a processing unit. 400 reads out, from an image DB 121 of a PACS apparatus 120, patient information, medical examination information, and a medical image of an examination to be displayed, and generates the viewer screen 310 based on the acquired information. The display processing unit 411 then performs a control such that the viewer screen 310 is displayed on the display 230a. Furthermore, the display processing unit 411 reads out interpretation report information from the report DB 131 of the reporting apparatus 130, and generates the interpretation report screen 320 based on the interpretation report information. The display processing unit 411 then displays the interpretation report screen 320 on the display 230b. Although not shown in FIG. 4, reading-out of image data from the image DB 121 and reading-out of the interpretation report information 500 from the report. DB 131 are performed via the network 110.

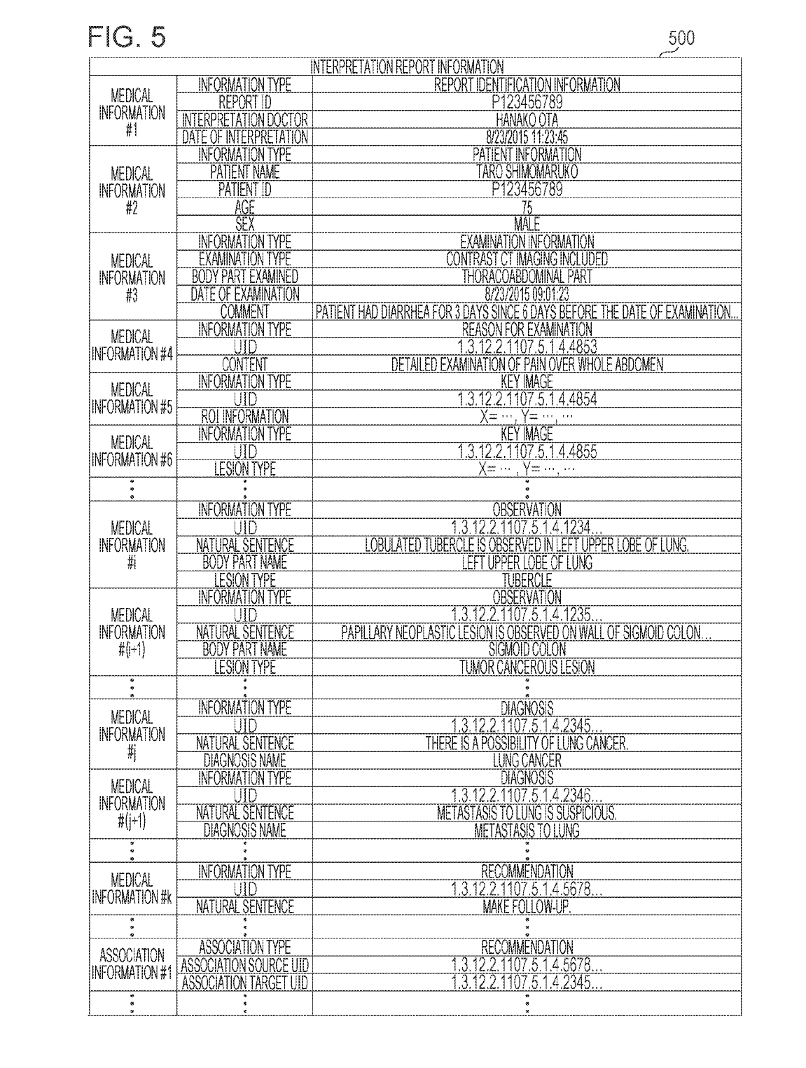

FIG. 5 illustrates an example of interpretation report information. The interpretation report information 500 includes a plurality of pieces of medical information and a plurality of pieces of association information. That is, the interpretation report information 500 is information that describes medical information and defines association information thereof. Note that when the terminal apparatus 100 displays the viewer screen and the report screen, the terminal apparatus 100 reads out the interpretation report information 500 from the reporting apparatus 130 and stores it in a storage unit such as the RAM 203 or the like of the terminal apparatus 100.

The medical information is information that is referred to in medical treatment/service or the like. Each piece of medical information includes a “information type” and “property information”. In the present embodiment, information types of medical information include “report identification information”, “patient information”, “medical examination information”, “reason for examination”, “key image”, “observation”, “diagnosis”, and “recommendation”. Note that the information types of medical information are not limited to those examples described above.

The association information is information indicating a relationship between two pieces of medical information. In the present embodiment, each piece of association information includes “association type” and “property information”. In the present embodiment, association types set to respective pieces of association information include “correspondence”, “cause/basis”, and “conflict”. Note that the association types of association information are not limited to those examples describe above.

Each piece of report identification information includes property information in terms of a report ID, an interpretation doctor, and an image capture date. Each piece of patient information includes property information in terms of a patient name, a patient ID, an age, and a sex. Each piece of medical examination information includes property information in terms of an examination type, an examination body part, an examination date, and a comment. Each key image includes property information in terms of a DID (Unique Identifier) uniquely identifying information, and ROI information indicating a lesion location. Each reason for an examination includes property information in terms of a UID and a content. Each observation includes property information in terms of a UID, a natural sentence representing the observation a body part name, and a lesion type. Each diagnosis includes property information in terms of a DUD, a natural sentence, and a diagnosis name. Each recommendation includes property information in terms of a UID and a natural sentence.

Each piece of association information includes property information in terms of an association source UID and an association target UID. To each of the association source and the association target, one of UIDs of “reason for examination”, “key image”, “observation”, “diagnosis”, and “recommendation” is set as a UID. Note that the above-described structures of information are merely examples, and the structures are not limited to these examples.

Referring again to FIG. 4, a specification acceptance unit 412 accepts, based on a particular inputting operation on the interpretation report screen 320, a specification that specifies at least one piece of medical information in the set of medical information displayed in the interpretation report screen 320. Hereinafter, set of medical information to be displayed refers to as set of displayed medical information. Note that the set of displayed medical information includes the reason for examination, the key image, and the observation described in the interpretation report, and medical information in terms of the information types of the diagnosis and the recommendation. Hereinafter, medical information specified by the specification acceptance unit 412 will be referred to as specified medical information. Examples of inputting operations include left-clicking of the mouse 220 on information, pressing an arrow key on the keyboard 210, and the like, but the inputting operations are not limited to these examples.

A first selection unit 413 selects medical information associated with the specified medical information, based on the association information on the interpretation report information 500 stored in the report DB 131. Herein there is no restriction on the type of the association. That is, the first selection unit 413 selects, based on the association information, medical information having some association with the specified medical information. Hereinafter, the medical information selected by the first selection unit 413 will be referred to as associated medical information. A type identifying unit. 414 identifies the type of specified medical information. (hereinafter referred to as the information type). The information type identified by the type identifying unit 414 is one of the following types: “reason for examination”, “key image”, “observation”, “diagnosis”, and “recommendation”.

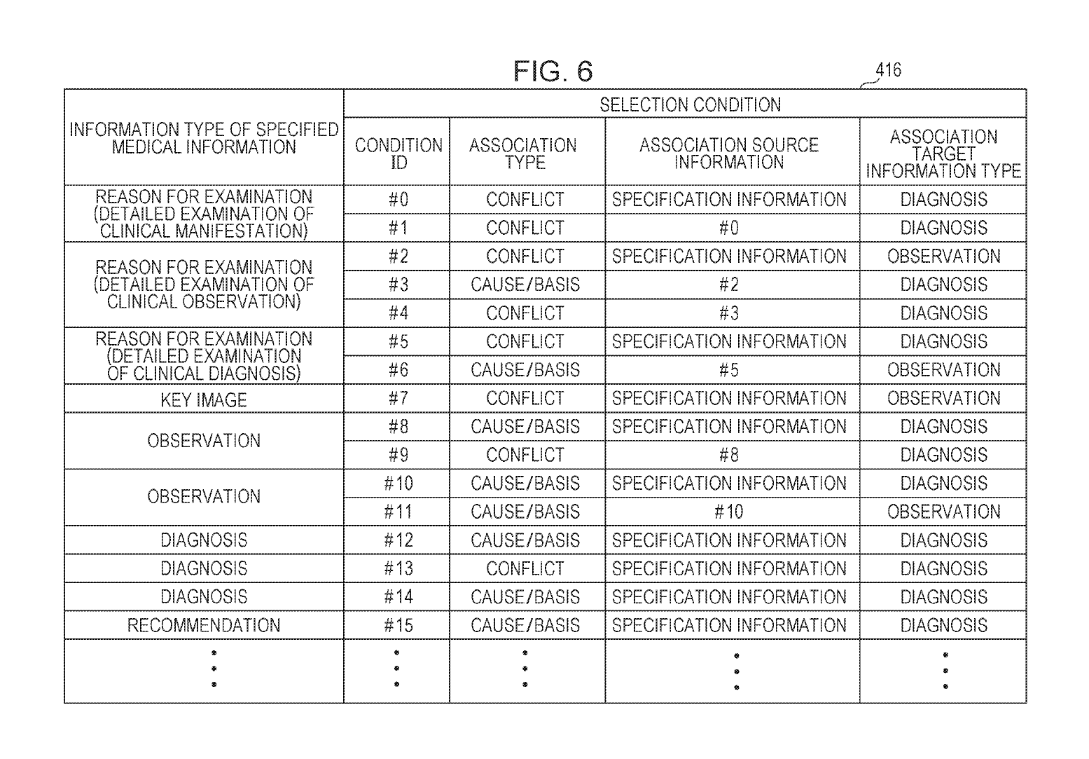

A selection condition DB 416 stores specified medical information and selection conditions for selecting medical information to be referred to by a user such as a doctor such that the selection conditions are associated to information types of specified medical information. Hereinafter, the medical information to be referred to by a user will be referred to as reference medical information. FIG. 6 is a diagram illustrating an example of the selection condition DB 416. In the selection condition DB 416, information types of specified medical information and selection conditions are stored in an associated manner.

Each selection condition includes a condition ID, an association type, an association source information. type, and an association target information type.

The information type of specified medical information is, as described above, one of the following types: “reason for examination”, “key image”, “observation”, “diagnosis”, and “recommendation”. Furthermore, in the present embodiment, the reason for an examination is classified into the following three detailed reasons: “detailed examination of clinical manifestation”, “detailed examination of clinical observation”, and “detailed examination of clinical diagnosis”. The detailed reason may be specified by a requesting doctor when a request is issued or may be specified by an interpretation doctor when interpretation is performed (in this case, the detailed reason is described in the interpretation report information 500), or the classifying may be performed automatically based on language analysis on a sentence describing a reason for an examination. Each information type is associated to one or more selection conditions.

The condition ID is identification information identifying a selection condition. In the example shown in FIG. 6, for example, condition IDs “#8” and “#9” are associated, as one set, to the information type “observation” of specified medical information. In this case, the set of “#8” and “#9” is treated as one selection condition. That is, one selection condition may include a plurality of conditions. Furthermore, condition IDs “#10” and “#11” are associated, as one set, to the information type “observation”. Thus, the information type “observation” is associated to two selection conditions, that is, the selection condition including the set of “#8” and “#9”, and the selection condition including the set of “#10” and “#11”.

The association type is information indicating a type of an association between specified medical information and reference medical information. In the present embodiment, the association type is one of the following types: “correspondence”, “cause/basis”, and “conflict”. The association source information is information specifying an association source. Specified medical information or a selection ID is set to the association source information. For example, for the selection condition having a condition ID “#1”, “#0” is set to the association source information. This means that reference medical information selected according to the selection condition “#0” is employed as association source information. Herein let it be assumed by way of example that there are two or more pieces of reference medical information that are selected according to the selection condition “#0”. In this case, for each of the two or more pieces of reference medical information, medical information determined according to the selection condition “#1” is selected as reference medical information.

The association target information type is information indicating a type of medical information selected as reference medical information. The association target information type is one of the following types: “reason for examination”, “key image”, “observation”, “diagnosis”, and “recommendation”. Note that the above-described structures of information are merely examples, and the structures are not limited to these examples. For example, a selection condition may be such a condition that in response to selecting “observation” or “diagnosis”, request information or a key image having a “corresponding” association or “recommendation” having a “cause/basis” association is selected.

Referring again to FIG. 4, a condition extraction unit 415 extracts, from the selection condition DB 416, a selection condition associated to an information type of specified medical information. In a case where an information type of specified medical information is associated to a plurality of selection conditions, the condition extraction unit 415 extracts these selection conditions. In this case, a selection condition in the first position in order of condition IDs of selection conditions is selected as default. Each time the keyboard 210 or the mouse 220 is operated, the selection condition is sequentially switched to a next selection condition. The method of determining the default selection condition and the method of switching the selection condition described above are merely examples, and the methods are not limited to these examples.

The selection conditions may be determined such that a determination is made, based on matching to a graph structure, as to the type of the information-to-information association, that is, as to whether the association between an observation and a diagnosis is of a one-to-many, many-to-one, or many-to-many correspondence, and the selection conditions are determined depending on the type of the association. The selection conditions may be determined such that the type of the information-to-information association is determined based on a direction of the association, and the selection conditions are determined depending on the type of the association, wherein the direction of the association may be defined such that when a diagnosis associated with an observation is selected, it is allowed or not allowed to get to another observation from the diagnosis.

A second selection unit 417 selects reference medical information satisfying the selection condition from associated medical information selected by the first selection unit 413. In the present embodiment, the first selection unit 413 selects associated medical information, and the second selection unit 417 selects reference medical information from the associated medical information. However, the details of the process of selecting reference medical information based on specified medical information and a selection condition are not limited to the examples described above.

Furthermore, to highlight reference medical information, the display processing unit 411 changes the appearance of the reference medical information to an appearance different from the appearance of medical information other than the reference medical information in the set of displayed medical information. The display processing unit 411 then performs a control such that the reference medical information is displayed in the changed appearance. Specific examples of changing the appearance include changing a display frame so as to be displayed in a thick line, changing a line type of a display frame, changing a color of a display frame from black to orange, changing a background color of medical information, changing a font color in a case where the medical information includes text information, and the like. Hereinafter, the changed appearance will be referred to as a highlight appearance. Highlighting the appearance of text may include but is not limited to changing a font property such as size, font color, background color, background pattern, font style (bold, underline), effect (outline, shadow, reflection, blink, and glow), etc. Furthermore, the display processing unit 411 changes the appearance of a line indicating an association between specified medical information and reference medical information. More specifically, the display processing unit 411 may change the thickness, the color, or the like of a line. Highlighting the appearance of an object such as a line may include but is not limited to changing an object property such as size, outline color, line type, fill color, fill pattern, thickness, effect (outline, shadow, reflection, translucency, edge blurring, 3D effects, blink, and glow), etc. The display processing unit 411 then performs a control such that an association icon associated with reference medical information is displayed. Here the association icon is information indicating an association between specified medical information and reference medical information defined in association information.

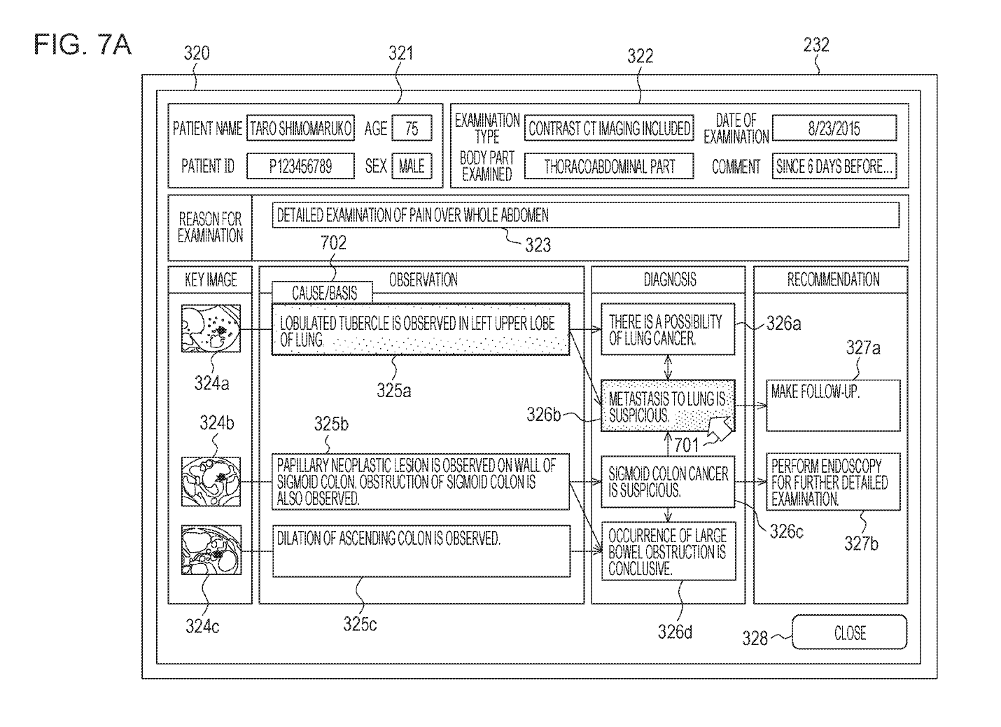

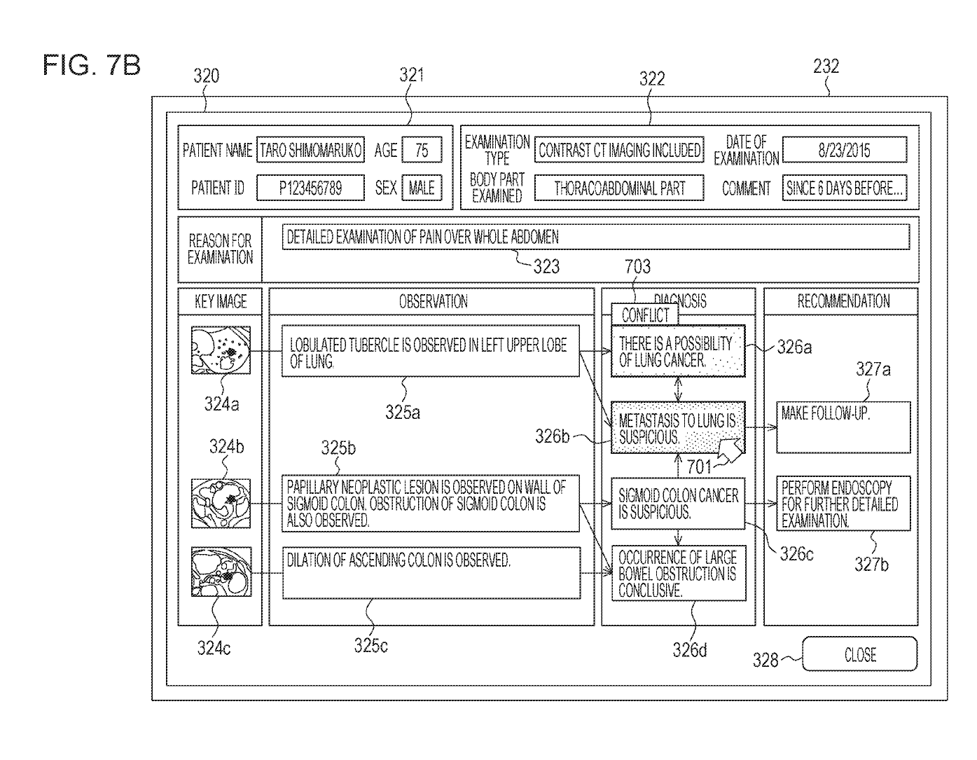

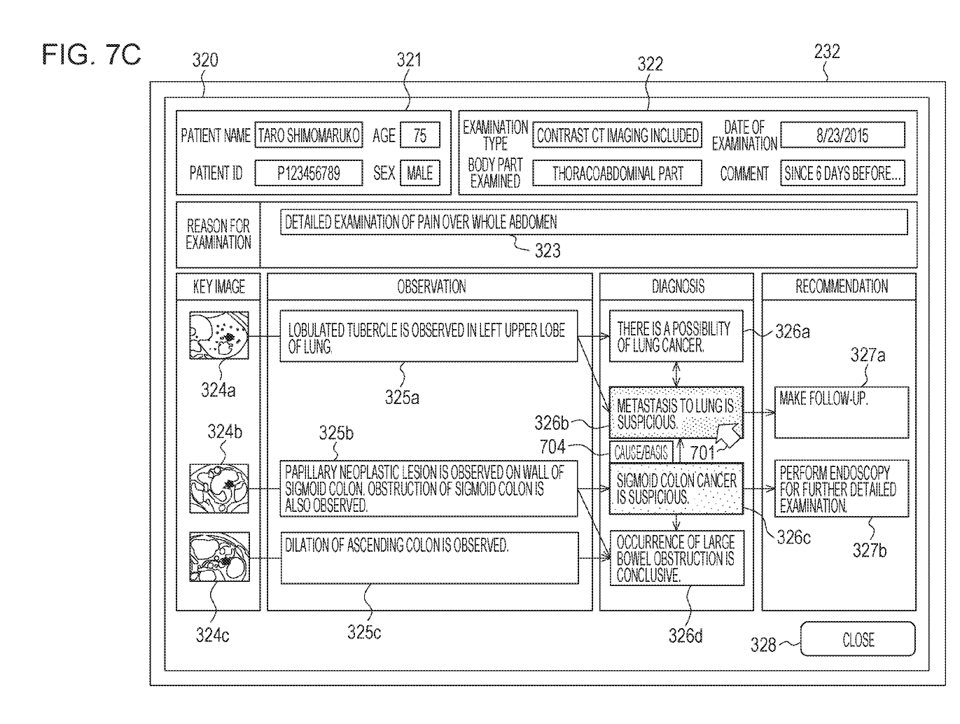

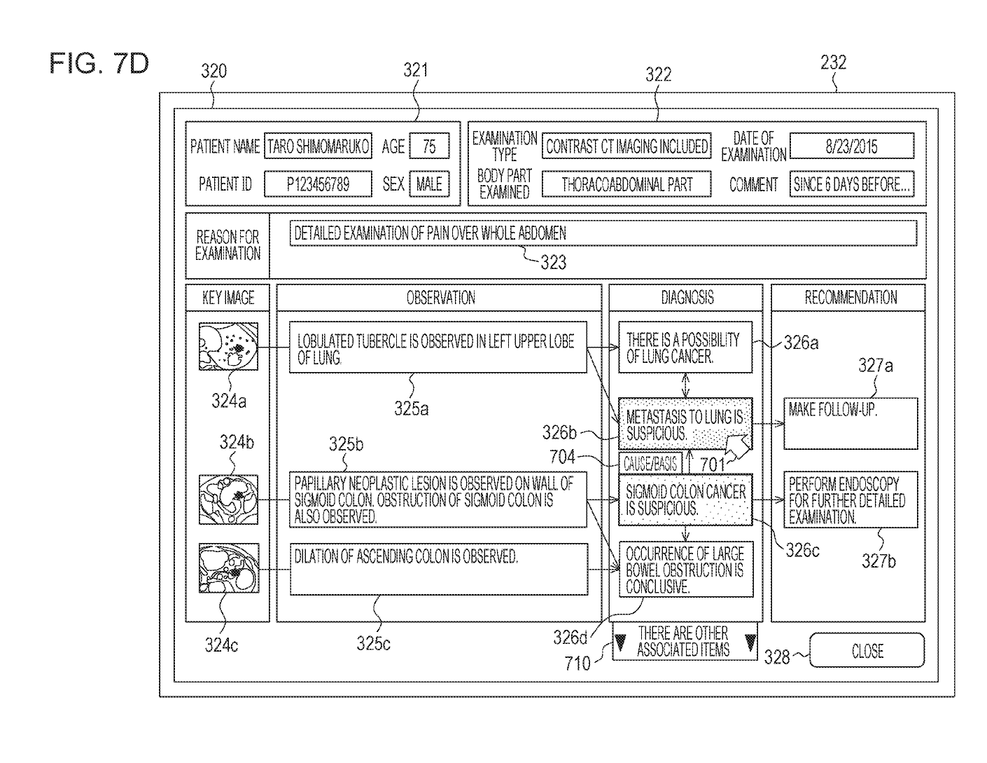

FIG. 7A to FIG. 7D are diagrams illustrating highlight appearances. Each of FIG. 7A to FIG. 7D illustrates an example of a manner of highlighting information for a case where the diagnosis 326b “metastasis to lung is suspicious” on the interpretation report screen 320 shown in FIG. 3B is specified. In these figures, 701 denotes a pointer.

FIG. 7A illustrates an example of a manner of highlighting information for a selection condition in which, in FIG. 6, the condition ID is “#12”, the association type is “cause/basis”, the association source information is “specified medical information”, and the association target information type is “observation”. Medical information of the information type of “observation” having an association of “cause/basis” to medical information “metastasis to lung is suspicious” is “lobulated tubercle is observed in left upper lobe of lung”. Thus, this medical information “lobulated tubercle is observed in left upper lobe of lung” is selected as reference medical information and displayed in the highlight mode. Furthermore, an association icon 702 indicating “cause/basis” as the association between the reference medical information and the specified medical information is displayed on an upper left corner of the medical information “lobulated tubercle is observed in left upper lobe of lung” specified as the reference medical information. This allows a user to recognize the reference medical information and understand the association between the reference medical information and the specified medical information.

Furthermore, in the present embodiment, the display processing unit 411 also displays the specified medical information in an appearance different from the appearance of medical information other than the specified medical information in the set of displayed medical information. Furthermore, the display processing unit 411 employs different appearances for the specified medical information and the reference medical information. For example, the display processing unit 411 may employ white as a default background color of medical information, and the display processing unit 411 may employ orange as the background color for reference medical information and red as the background color for specified medical information. This makes it possible to more clearly present, to a user, the association of each piece of medical information. In an alternative example, the display processing unit 411 may display specified medical information and reference medical information in an appearance different from the appearance for medical information other than the specified medical information and reference medical information, while the display processing unit 411 may display the specified medical information and the reference medical information in the same appearance.

FIG. 7B illustrates an example of a manner of highlighting information for a case where the selection condition is that the condition ID is “#13”, the association type is “conflict”, the association source information is “specification information”, and the association target information type is “diagnosis”. Medical information of the information type of “diagnosis” having an association of “conflict” to medical information “metastasis to lung is suspicious” is medical information “there is a possibility of lung cancer”. Thus, this medical information “there is a possibility of lung cancer” is selected as reference medical information and displayed in a highlight appearance. Furthermore, an association icon indicating “conflict” as the association between the reference medical information and the specified medical information is displayed on an upper left corner of the medical information “there is a possibility of lung cancer” specified as the reference medical information.

FIG. 7C illustrates an example of a manner of highlighting information for a case where the selection condition is that the condition ID is “#14”, the association type is “cause/basis”, the association source information is “specification information”, and the association target information type is “diagnosis”. Medical information of the information type “diagnosis” having an association of “cause/basis” to the medical information “metastasis to lung is suspicious” is “sigmoid colon cancer is suspicious”. Thus, this medical information “sigmoid colon cancer is suspicious” is selected as reference medical information and displayed in the highlight mode. Furthermore, an association icon 704 indicating “cause/basis” as the association between the reference medical information and the specified medical information is displayed on an upper left corner of the medical information “sigmoid colon cancer is suspicious” specified as the reference medical information.

In the example shown in FIG. 6, two conditions having condition. IDs “#8” and “#9” are associated to the information type “observation” of the specified medical information. As in this example, there is a possibility that a plurality of conditions are associated, as one set of conditions, to one piece of information type. In this case, reference medical information satisfying each condition is selected, and all selected reference medical information is displayed at the same time in the highlight appearance. Furthermore, in the example shown in FIG. 6, two conditions having condition IDs “#10” and “#11” are associated to the information type “observation”. Thus, reference medical information corresponding to the two conditions having the condition IDs “#10” and “#11” and reference medical information corresponding to the two conditions having the condition IDs “#8” and “#9” are alternately displayed.

In a case where in addition to medical information 326c “sigmoid colon cancer is suspicious”, there is further medical information of the information type “diagnosis” having an association of “cause/basis” to the medical information 326b “metastasis to lung is suspicious” of the information type “diagnosis”, then, as illustrated in FIG. 7D, an icon 710 is displayed to indicate that there are more associated items. In a case where medical information associated with displayed medical information of the information type “diagnosis” exists in a lower outside area adjacent to the display range, the icon 710 is displayed on a lower side of the display range. On the other hand, in a case where medical information associated with displayed medical information of the information type “diagnosis” exists in an upper outside area adjacent to the display range, the icon 710 is displayed on an upper side of the display range. When associated medical information is displayed outside the display range, the medical information may be displayed in a reduced form, or the screen may be divided into sub-screen areas, and the medical information may be displayed in one of the sub-screen areas. This makes it possible for a user to easily recognize such associated information even in the case where the information exists outside the display range.

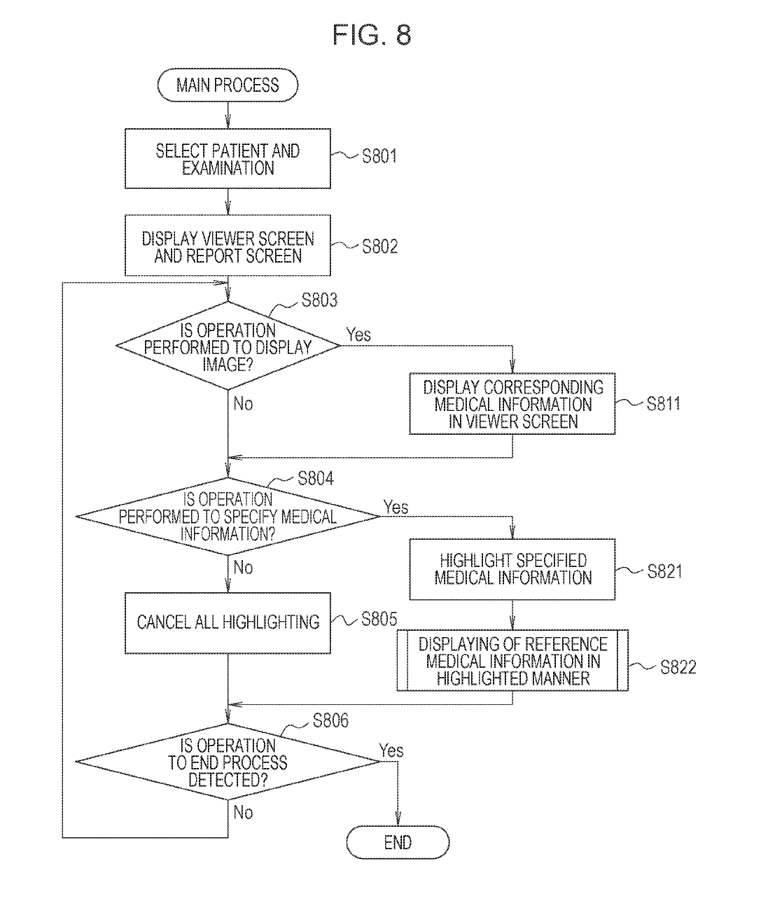

FIG. 8 is a flow chart illustrating a main process performed by the terminal apparatus 100. In S801, the CPU 202 of the terminal apparatus 100 accepts a selection of an examination for a patient to be displayed in response to an input operation performed by a user via the keyboard 210 or the like. Next, in S802, the display processing unit 411 reads out, from the report DB 131, interpretation report information 500 corresponding to the selected patient and the examination. The display processing unit 411 then displays the viewer screen 310 and the interpretation report screen 320 respectively on the displays 230a and 230h. In this process, a first-position slice image of a particular medical image corresponding to the examination may be selected from the image DB 121 and may be displayed as a default image on the viewer screen 310.

Next, in S803, when the CPU 202 detects an operation to display an image, such as clicking on a key image on the interpretation report screen 320 or the like (Yes in S803), the CPU 202 advances the process to S811. In a case where the CPU 202 detects no operation to display an image (No in S803), the CPU 202 advances the process to S804.

In S811, the display processing unit 411 performs a control such that medical information (a medical image, a graphical image, an observation) corresponding to the key image is displayed in the viewer screen 310. In the example shown in FIGS. 3A and 3B, when the key image 324a is selected, the medical image 314 and the display frame 316 for the corresponding observation are displayed. In this process, the location where the medical image is displayed on the viewer screen 310 is determined according to a particular hanging protocol or, in a case where an image of the same examination is already displayed, the location thereof is employed.

Next, in S804, when the CPU 202 detects an operation of specifying medical information by clicking a reason for an examination, an observation, a diagnosis, a recommendation, or the like on the interpretation report screen 320 being displayed on the display 230b (Yes in S804), the CPU 202 advances the process to S821. On the other hand, in a case where the CPU 202 detects no operation of specifying medical information (No in S804), the CPU 202 advances the process to S805. Note that in a case where an operation of specifying medical information is detected, the specification acceptance unit 412 accepts the specifying of the medical information.

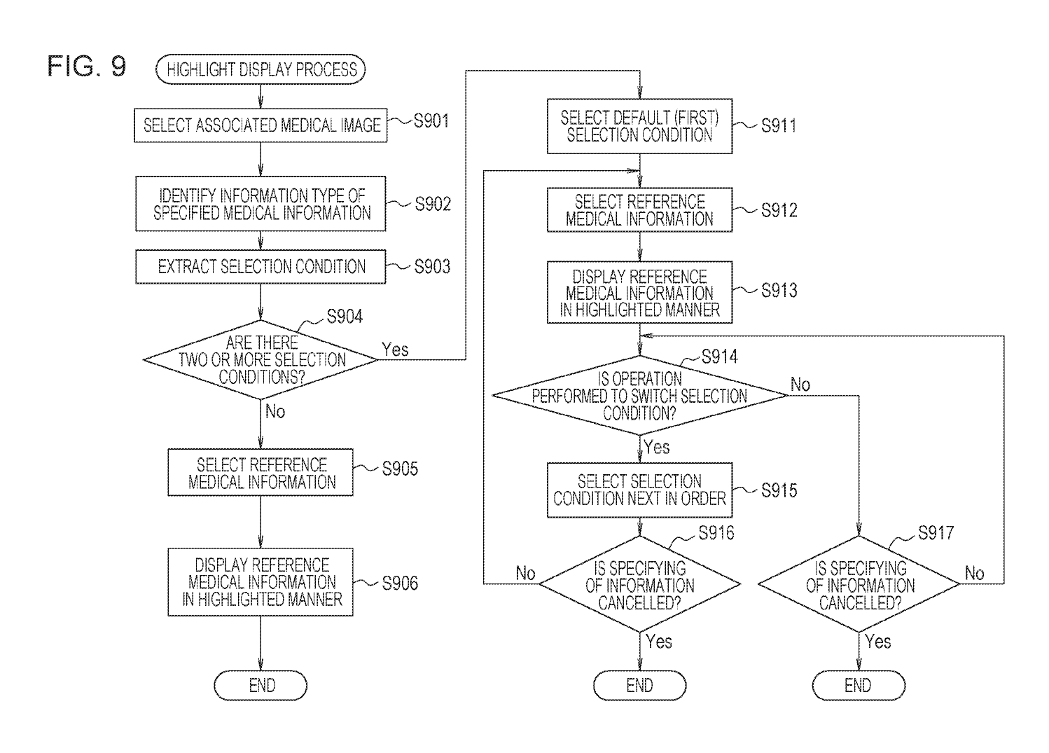

In S821, the display processing unit 411 performs a control such that the specified medical information is displayed in a highlight appearance. Next, in S822, the display processing unit 411 performs a control such that reference medical information to he referred to by a user is displayed in a highlight appearance together with the specified medical information. The details of the process in S822 will be described later with reference to FIG. 9. Thereafter, the CPU 202 advances the process to S806. In S805, the CPU 202 cancels all highlighting. Thereafter, the CPU 202 advances the process to S806. Next, in S806, when the CPU 202 detects an operation to end the process, for example, by clicking a “close” button 328, (Yes in S806), the CPU 202 ends the process. In a case where the CPU 202 does not detect the operation to end the process (No in S806), the CPU 202 advances the process to S803.

FIG. 9 is a flow chart illustrating the details of the process of displaying reference medical information in the highlight appearance performed in S822 (described above with reference to FIG. 8) by the terminal apparatus 100. In S901, the first selection unit 413 selects associated medical information associated to specified medical information based on association information included in interpretation report information 500 corresponding to the specified medical information. Next, in S902, the type identifying unit 414 identifies the information type of the specified medical information. Next, in S903, the condition extraction unit 415 extracts, from the selection condition DB 416, all selection conditions associated to the information type of the specified medical information. Let it be here assumed by way of example that the information type of the specified medical information is “observation”. In this case, in the example shown in FIG. 6 the condition extraction unit 415 extracts two sets of selection conditions, that is, the set of “#8” and “#9” and the set of “#10” and “#11”.

Next, in S904, the CPU 202 determines whether a plurality of selection conditions have been extracted. In a case where the CPU 202 determines that a plurality of selection conditions have been extracted (Yes in S904), the CPU 202 advances the process to S911. In a case where a plurality of selection conditions are not extracted, that is, in a case where only one selection condition is extracted, (No in S904), the CPU 202 advances the process to S905. In S905, the second selection unit 417 selects medical information, as reference medical information, satisfying the selection condition from associated medical information selected by the first selection unit 413. Next, in S906, the display processing unit 411 changes the appearance of the reference medical information to an appearance different from an appearance of other medical information. The display processing unit 411 then performs a control such that the reference medical information is displayed in the changed appearance. That is, the display processing unit 411 performs the control such that the reference medical information is displayed in a highlight appearance. Thereafter, the process is ended.

On the other hand, in S911, the condition extraction unit 415 selects one selection condition in the ascending order of condition IDs. In the case where two sets of selection conditions, that is, the set of “#8” and “#9” and the set of “#10” and “#11” are extracted for the information type “observation” of specified medical information as described above, the condition extraction unit 415 selects, from these two sets, the set of “#8” and “#9” as the first selection condition. Next, in S912, the second selection unit 417 selects associated medical information as reference medical information satisfying the selection condition selected in S911 from the associated medical information selected by the first selection unit 413. In the case of the selection condition of the set of “#8” and “#9”, associated medical information satisfying “#8” and associated medical information satisfying “#9” and are respectively selected as reference medical information.

Next, in S913, the display processing unit 411 changes the appearance of the reference medical information to an appearance different from an appearance of other medical information. The display processing unit 411 then performs a control such that the reference medical information is displayed in the changed appearance. That is, the display processing unit 411 performs the control such that the reference medical information is displayed in a highlight appearance. Note that the process in S913 is similar to the process in S906. The selection condition of the condition ID “#8” is defined such that reference medical information is selected which satisfies that the association type of the specified medical information is “cause/basis” and the type of the association target information is “diagnosis”. On the other hand, in a case where, for example, the observation 325b in FIG. 3B is specified, the diagnosis 326c and the diagnosis 326d in FIG. 3B are selected as reference medical information based on the selection condition “#8” and are displayed in a highlight appearance. Note that reference medical information corresponding to “#9” does not exist for the observation 25b shown in FIG. 3B.

Next, in S914, the CPU 202 determines whether an operation of switching the selection condition (hereinafter also referred to as a switching operation) is performed. Herein, the switching operation is an operation of clicking medical information or the like. If a switching operation is detected, the CPU 202 accepts a switching command. In a case where the CPU 202 detects a switching operation (Yes in S914), the CPU 202 advances the process to S915. In a case where the CPU 202 does not detect a switching operation (No in S914), the CPU 202 advances the process to S917. In S915, the condition extraction unit 415 selects a selection condition having a condition ID which small next to the condition ID of the selection condition being currently selected.

In S915, furthermore, the display processing unit 411 stops the highlight displaying being performed, and returns the appearance to a previous appearance. For example, let it be assumed here by way of example that two sets of selection conditions, that is, the set of “#8” and “#9” and the set of “#10” and “#11” have been extracted, and the set of “#8” and “#9” has been selected as the first selection condition. In this case, in S915, the condition extraction unit 415 selects the set of “#10” and “#11” as the next selection condition. Furthermore, the display processing unit 411 ends the highlighting of the reference medical information for the set of “#8” and “#9”.

Next, in S916, the CPU 202 determines whether an operation of cancelling specifying information is performed. In a case where a cancelling operation is detected (Yes in S916), the CPU 202 ends the process. In a case where a cancelling operation is not detected (No in S916), the CPU 202 advances the process to S912. Also in S917, the CPU 202 determines whether a cancelling operation is performed. In a case where a cancelling operation is detected (Yes in S917), the CPU 202 ends the process. In a case where a cancelling operation is not detected (No in S917), the CPU 202 advances the process to S914.

As described above, the terminal apparatus 100 according to the present embodiment narrows the reference medical information depending on whether the information type of medical information specified by a user is request, “observation”, “diagnosis”, and presents the resultant reference medical information to the user. That is, the terminal apparatus 100 is capable of presenting proper information depending on a reason for an examination.

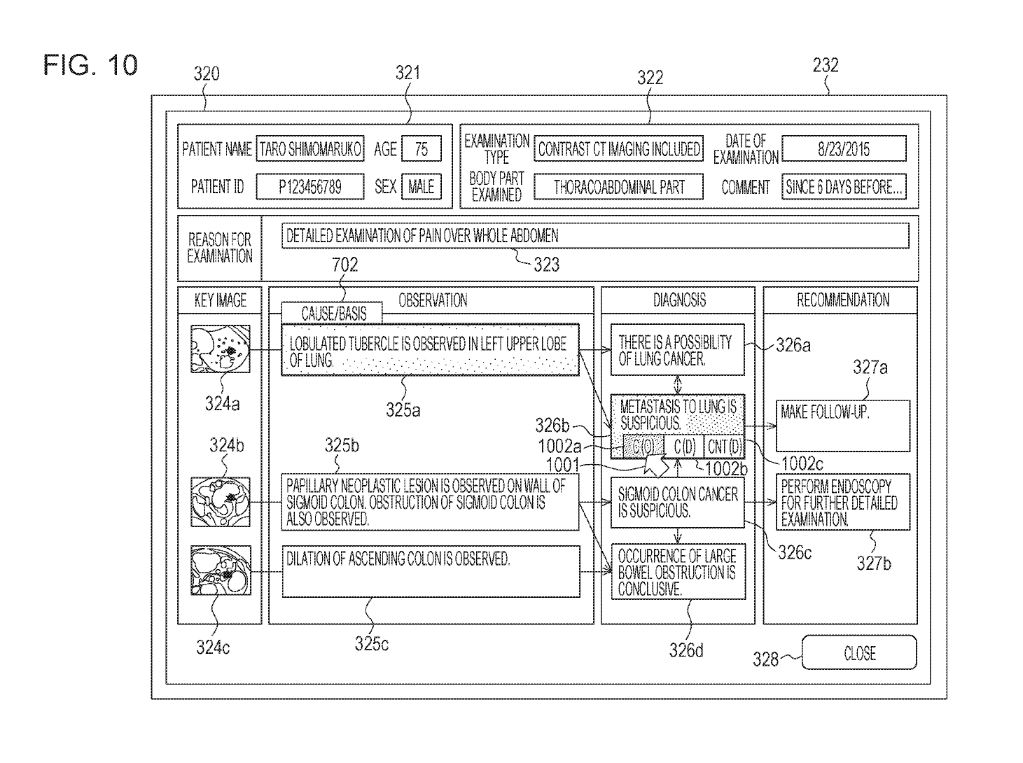

Next, a first modification of the medical document display system of the first embodiment is described below. FIG. 10 is a diagram illustrating a first modification of highlight displaying. As shown in FIG. 6, three selection conditions are associated to the medical information “metastasis to lung is suspicious” whose information type is “diagnosis” shown in FIG. 7A to FIG. 7C. In this case, the display processing unit 411 may display three icons 1002a, 1002b, and 1002c respectively indicating associations corresponding to the three selection conditions such that they are displayed in a lower right area of the medical information “metastasis to lung is suspicious”.

As shown in FIG. 10, when the icon 1002a is selected by a pointer 1001, the display processing unit 411 performs a control such that the medical information 325a is displayed in a highlight appearance. In a case where the icon 1002b is selected, the display processing unit. 411 performs a control such that the medical information 326c is displayed in a highlight appearance. In this case, for example, displaying may be performed in a similar manner as illustrated in FIG. 7C. When the icon 1002c is selected, the display processing unit 411 performs a control such that the medical information 326a is displayed in a highlight appearance. In this case, for example, displaying may be performed in a similar manner as illustrated in FIG. 7B. In these cases, an association icon displayed on an upper left corner of the highlighted reference medical information.

In a second modification, when an association icon is displayed, the display processing unit 411 may perform a control such that the association icon is displayed at any location as long as the location allows it to recognize a correspondence association to the reference medical information, and the display location and the appearance are not limited to examples described above. Note that the display processing unit 411 may not display the association icon.

In a third modification, the terminal apparatus 100 may select reference medical information based on an association between an information type of specified medical information and an information type of other medical information, but the process of selecting the reference medical information is not limited to the above-described examples according to the embodiment. In an alternative example, a selection condition may not include a condition that limits (specifies) an information type of association target information. In this case, the terminal apparatus 100 may select, as reference medical information, medical information identified from an association type without being limited by an information type. In a still alternative example, a selection condition may not include an association type. In this case, the terminal apparatus 100 may select reference medical information based on association target information type associated to specified medical information without identifying an association type.

### Second Embodiment

Next, a document display system according to a second embodiment is described below. In the second embodiment, in a case where a plurality of selection conditions are extracted for specified medical information, the terminal apparatus 100 performs a control such that all pieces of reference medical information selected based on the respective selection conditions are displayed at the same time. In this case, the terminal apparatus 100 further performs a control such that the pieces of reference medical information selected based on the respective selection conditions are displayed in appearances different from each other.

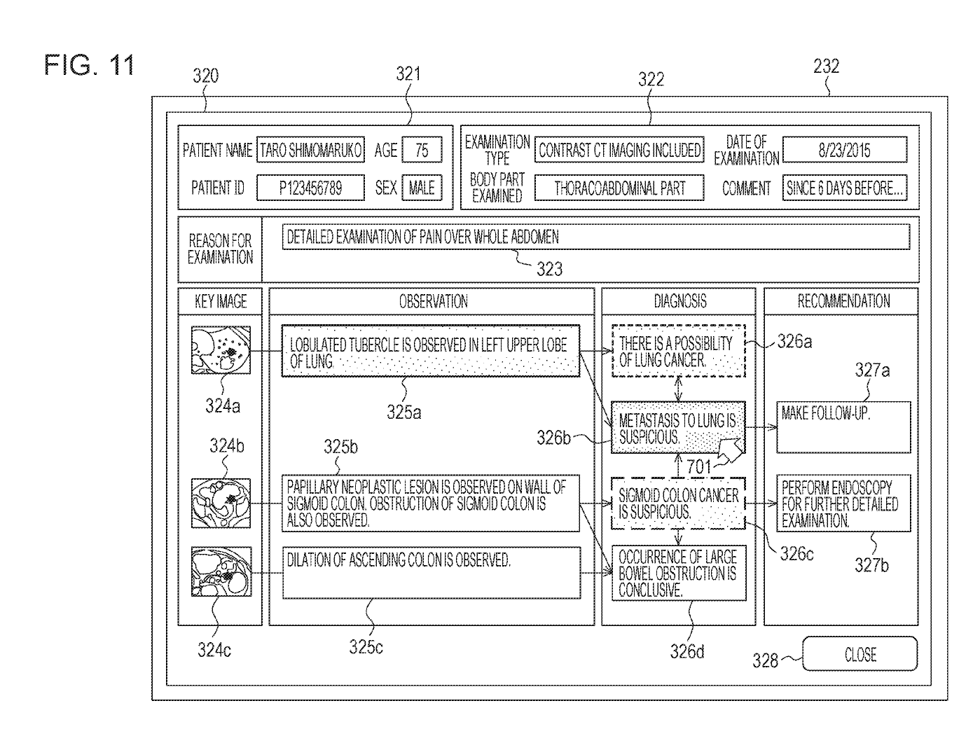

FIG. 11 is a diagram illustrating an example of highlighting information according to the second embodiment. In a case where the diagnosis 326b is specified, three pieces of reference medical information of the information type “diagnosis” selected according to three selection conditions “#12”, “#13”, and “#14” are displayed in appearances different from each other. In the example shown in FIG. 11, a display frame of the observation 325a corresponding to the selection condition “#12” is displayed in a solid line, a display frame of the diagnosis 326a corresponding to the selection condition “#13” is displayed in a short broken line, and a display frame of the diagnosis 326c corresponding to the selection condition “#14” is displayed in a long broken line. Note that the three different highlight appearances described above are merely examples, and the appearances are not limited to these examples.

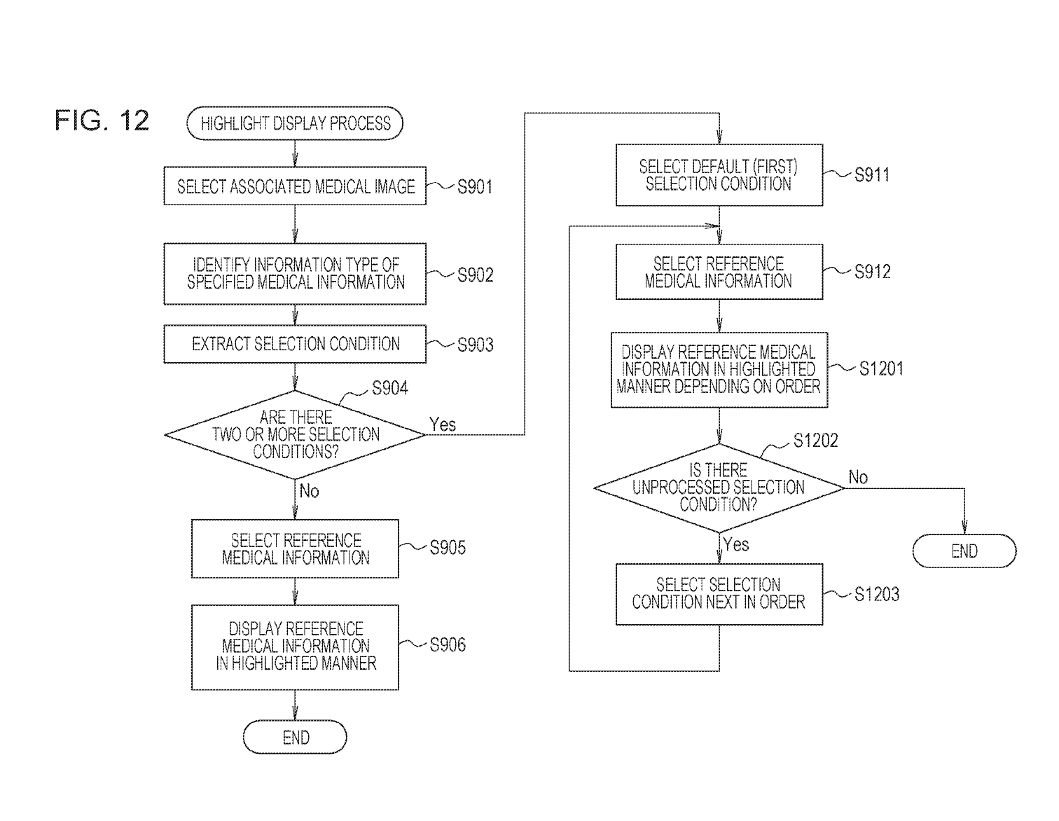

FIG. 12 is a flow chart illustrating the details of the process (in S822) of displaying reference medical information in the highlight appearance according to the second embodiment. Note that in the highlight display process shown in FIG. 12, similar processing steps to those according to the first embodiment described above with reference to FIG. 9 are denoted by similar reference symbols.

In the second embodiment, after the process in S912 is performed, the CPU 202 advances the processing flow to S1201. In S1201, the display processing unit 411 performs a control such that reference medical information is displayed in a highlight appearance depending on an order of a corresponding selection condition. For example, condition IDs of selection conditions may be assigned serial numbers in the ascending order, and different appearances are assigned in advance depending on the order, for example, such that a solid line is assigned to the first selection ID, a short broken line is assigned to the second selection ID, and a long broken line is assigned to the third selection ID. This correspondence association may be set in advance in the storage medium 204 or the like of the terminal apparatus 100.

Next, in S1202, the CPU 202 determines whether there is an unprocessed selection condition. In a case where there is an unprocessed selection condition (Yes in S1202), the CPU 202 advances the processing flow to S1203. In a case where there is no unprocessed selection condition (No in S1202), the CPU 202 ends the process. The configuration and the process of the document display system according to the second embodiment are similar to those, except for the points described above, of the document display system according to the first embodiment.

In the terminal apparatus 100 according to the second embodiment, as described above, in a case where there are a plurality of pieces of reference medical information associated, via respective selection conditions, with specified medical information, these pieces of reference medical information are displayed in appearances different from each other. That is, the terminal apparatus 100 is capable of displaying a plurality of pieces of proper medical information depending on a reason for an examination such that they are displayed in a distinguishable manner.

### Third Embodiment

Next, a document display system according to a third embodiment is described below. According to the third embodiment, a plurality of pieces of reference medical information respectively corresponding to a plurality of pieces of association information are selected according to one selection condition for specified medical information, the terminal apparatus 100 performs a control such that these pieces of reference medical information are all displayed on the screen. Furthermore, in this case, the terminal apparatus 100 performs a control such that different pieces of reference medical information corresponding to the respective pieces of association information are displayed in appearances different from each other.

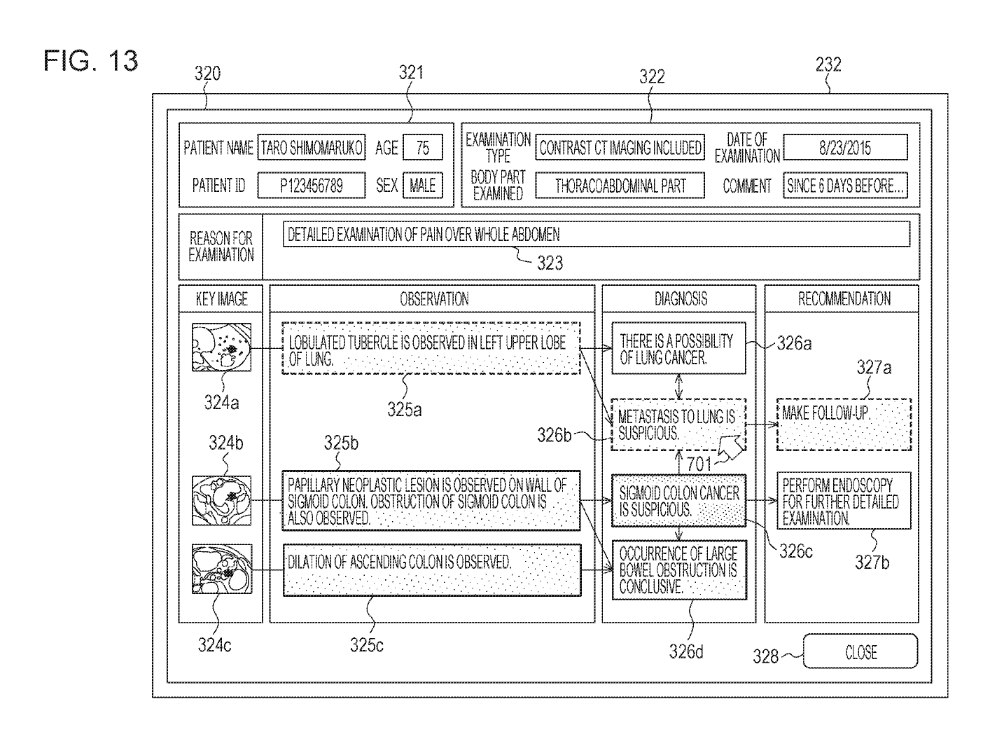

FIG. 13 is a diagram illustrating an example of highlighting information according to the second embodiment. Therein, let it be assumed by way of example that the selection conditions are selecting “diagnosis” having an association of “cause/basis” to specified medical information, selecting “observation” and “recommendation” having an association of “cause/basis” to this “diagnosis”, and selecting “key image” having an association of “correspondence” to this “observation”. In this situation, let it be assumed by way of example that the diagnosis 326b is selected as shown in FIG. 13.

In this case, according to the selection condition, an information set including the diagnosis 326b and other related information, i.e., the key image 324a, the observation 325a, and the recommendation 327a, and thus including a total of four pieces of reference medical information, is selected. Furthermore, according to the same selection condition, an information set including the diagnosis 326d and other related information, i.e., the key image 324b, the observation 325b, the key image 324c, and the observation 325c and thus including a total of five pieces of reference medical information, is selected. These two information sets correspond to associated medical information associated by different pieces of association information associated to the specified medical information. In the example shown in FIG. 13, display frames of the first information set are each represented in a broken line, and display frames of the second information set are each represented in a solid line.

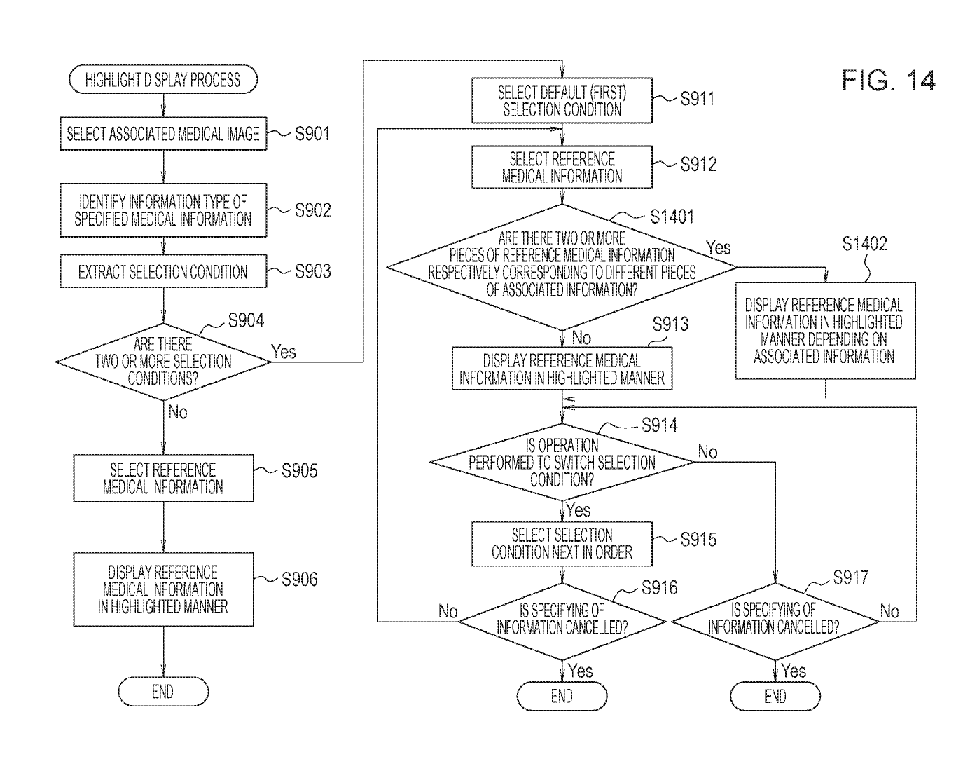

FIG. 14 is a flow chart illustrating the details of the process (in S822) of displaying reference medical information in the highlight appearance according to the third embodiment. Note that in the highlight display process shown in FIG. 14, similar processing steps to those according to the first embodiment described above with reference to FIG. 9 are denoted by similar reference symbols.

In the third embodiment, after the process in S912 is performed, the CPU 202 advances the processing flow to S1401. In S1401, the second selection unit 417 determines whether there are a plurality of pieces of reference medical information respectively corresponding to different pieces of association information. Note that in a case where there are a plurality of pieces of association information corresponding to the selected reference medical information, the second selection unit 417 determines that there are a plurality of pieces of reference medical information respectively corresponding to different pieces of association information. In a case where there are a plurality of pieces of reference medical information respectively corresponding to different pieces of association (Yes in S1401), the second selection unit 417 advances the processing flow to S1402. In a case where the determination is negative as to whether there are a plurality of pieces of reference medical information respectively corresponding to different pieces of association, (No in S1401), the second selection unit 417 advances the processing flow to S913.

In S1402, the display processing unit 411 changes the appearance for the plurality of pieces of reference medical information selected according to the respective pieces of association information to appearances different from each other depending on the corresponding pieces of association information. The display processing unit 411 then performs a control such that each piece of reference medical information is displayed in the corresponding changed appearance. The configuration and the process of the document display system according to the third embodiment are similar to those, except for the points described above, of the document display system according to the first embodiment.

In the third embodiment, as described above, in a case where a plurality of pieces of reference medical information respectively corresponding to a plurality of pieces of association information are selected according to one selection condition of the specified medical information, the terminal apparatus 100 displays these selected pieces of specified medical information in appearances different from each other. That is, the terminal apparatus 100 is capable of displaying a plurality of pieces of proper medical information depending on a reason for an examination such that they are displayed in a distinguishable manner.

While the present disclosure has been described with reference to exemplary embodiments, it is to be understood that the disclosure is not limited to the disclosed exemplary embodiments. Various modifications and changes are possible without departing from the scope of the present disclosure.

### Other Embodiments

The present disclosure may he realized in various forms such as a system, an apparatus, a method, a program, or a storage medium (storage medium). More specifically, the present disclosure may be applied to a system including a plurality of devices (such as a host computer, an interface device, an image capturing apparatus, a web application, and the like) or may be applied to an apparatus including only a single device.

The present disclosure can also be realized as follows. That is, a software program code (computer program) for realizing one or more functions of the embodiments is stored in a storage medium. (or a storage medium) and the storage medium (or the storage medium) is supplied to a system or an apparatus. Note that the storage medium is a computer-readable storage medium. The software program code stored in the medium is read out by a computer (or a CPU or an MPU) of the system or the apparatus, and executed. In this case, the program code read from the storage medium implements the functions disclosed in the embodiments described above, and the storage medium in which the program code is stored falls within the scope of the present disclosure.

The embodiments of the present disclosure are capable of presenting proper information to a user.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above--described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™) a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-080603 filed Apr. 13, 2016, which is hereby incorporated by reference herein in its entirety.

What is claimed is:

1. An information processing system comprising:
one or more processors;
an acceptance unit configured to accept a specification of one piece of medical information in a set of medical information being displayed on a display unit;
a selection unit configured to select reference medical information from the set of medical information based on an association between a type of the specified medical information and a type of medical information which belongs to the set of medical information and which is different from the specified medical information; and
a change unit configured to change an appearance of the reference medical information to an appearance different from an appearance of medical information other than the reference medical information in the set of medical information.

2. The information processing system according to claim 1, wherein the selection unit is configured to select medical information as the reference medical information to be referred to by a user together with the specified medical information.

3. The information processing system according to claim 1, wherein the change unit is configured to change the appearance of the specified medical information to an appearance different from an appearance of medical information other than the specified medical information in the set of medical information.

4. The information processing system according to claim 1, wherein the selection unit is configured to select the reference medical information by referring, based on the association between the type of the specified medical information and the type of the other medical information, to a selection condition which is condition for selecting the reference medical information and which is set in advance.

5. The information processing system according to claim 4, further comprising an extraction unit configured to extract a selection condition associated to the type of specified medical information from a first storage unit in which selection conditions are stored in associated to types of specified medical information; and
wherein the selection unit is configured to select the reference medical information by referring to the selection condition extracted by the extraction unit.

6. The information processing system according to claim 5, wherein the selection unit is configured to select reference medical information such that in a case where a plurality of selection conditions are extracted for the specified medical information, the selection unit selects reference medical information for each of a plurality of extracted selection conditions.

7. The information processing system according to claim 6, wherein the change unit is configured to change appearances of the plurality of pieces of reference medical information selected according to the respective selection conditions to appearances different from each other.

8. The information processing system according to claim 6, further comprising a display processing unit configured to display, on the display unit, an association defined in a selection condition associated to each of the plurality of pieces of reference medical information.

9. The information processing system according to claim 5, the selection unit is configured to select reference medical information such that in a case where a plurality of selection conditions are extracted for the specified medical information, according to one of the plurality of extracted selection conditions.

10. The information processing system according to claim 9, wherein
the selection unit is configured to select reference medical information such that in a case where a command to switch the selection condition is accepted, the selection unit selects reference medical information according to a second selection condition which is included in the plurality of selection conditions extracted for the specified medical information and which is different from the one of the selection conditions, and
the change unit is configured to change an appearance of the reference medical information selected according to the second selection condition to an appearance different from an appearance of medical information other than the reference medical information, and return the appearance of the reference medical information selected according to the one of the selection conditions to the previous appearance employed before the appearance is changed.

11. The information processing system according to claim 4, wherein the selection condition further includes a condition for specifying a type of the reference medical information.

12. The information processing system according to claim 1, wherein the selection unit is configured to select the reference medical information such that association information associated to the specified medical information is acquired from a second storage unit in which association information indicating the association of the specified medical information is stored in association with the specified medical information, and the reference medical information is selected based on the acquired association information.

13. The information processing system according to claim 12, wherein the selection unit is configured to select reference medical information such that in a case where a plurality of pieces of association information are associated to one piece of specified medical information, based on each of the plurality of pieces of association information.

14. The information processing system according to claim 13, wherein the change unit is configured to change appearances of the plurality of pieces of reference medical information selected based on the respective pieces of association information to appearances different from each other.

15. The information processing system according to claim 4, wherein the selection unit is configured to select reference medical information such that association information associated to the specified medical information is acquired from a second storage unit in which the specified medical information is stored in association with the association information indicating the association of the specified medical information, and associated medical information associated with the specified medical information is selected based on the acquired association information and then, based on the selection condition, the reference medical information is selected from the associated medical information.

16. The information processing system according to claim 1, wherein the change unit is configured to highlight the appearance of the reference medical information.

17. The information processing system according to claim 1, wherein changing the appearance includes one or more of:
changing a display frame of the reference medical information so as to be displayed in a line that thicker than a line used to display the medical information other than the reference medical information;
changing a line type of the display frame of the reference medical information so as to be different from a line type used by the medical information other than the reference medical information;
changing a color of the display frame of the reference medical information so as to be different from a color used by the medical information other than the reference medical information;
changing a background color of the reference medical information so as to be different from a background color used by the medical information other than the reference medical information; and
changing a font color of the reference medical information so as to be different from a font color used by the medical information other than the reference medical information.

18. The information processing system according to claim 1, wherein changing the appearance includes one or more of: changing a font appearance property or an object appearance property,
wherein the font appearance property includes: color; style; size, and effect; and
wherein the object appearance property includes: color; style; size; thickness, and effect.

19. An information processing method comprising:
accepting a specification of one piece of medical information in a set of medical information being displayed on a display unit;
selecting reference medical information to be referred to by a user together with the specified medical information from a set of medical information based on an association between a type of the specified medical information and a type of medical information which belongs to the set of medical information and which is different from the specified medical information; and
changing an appearance of the reference medical information to an appearance different from an appearance of medical information other than the reference medical information in the set of medical information.

20. A non-transitory recording medium storing a program for causing a computer to execute a process comprising:
accepting a specification of one piece of medical information in a set of medical information being displayed on a display unit;
selecting reference medical information to be referred to by a user together with the specified medical information from a set of medical information based on an association between a type of the specified medical information and a type of medical information which belongs to the set of medical information and which is different from the specified medical information; and
changing an appearance of the reference medical information to an appearance different from an appearance of medical information other than the reference medical information in the set of medical information.
